(19) United States
(12) Patent Application Publication
(10) Pub. No.: US 2025/0229856 A1
(43) Pub. Date: Jul. 17, 2025

(54) TRAILER MOUNTED INTERCOM

(71) Applicants: Miller Anyogu, Locust, NC (US); Brian Anyogu, Locust, NC (US)

(72) Inventors: Miller Anyogu, Locust, NC (US); Brian Anyogu, Locust, NC (US)

(21) Appl. No.: 19/018,630

(22) Filed: Jan. 13, 2025

Related U.S. Application Data
(60) Provisional application No. 63/619,981, filed on Jan. 11, 2024.

(51) Int. Cl. B62D 63/08; H04B 1/3888; H04M 1/02

(52) U.S. Cl. CPC B62D 63/08; H04B 1/3888; H04M 1/0202

(57) ABSTRACT

An intercom and mobile apparatus system providing an intercom having a main housing defining a compartment; a mounting plate connected directly to a rear surface of the main housing, the mounting plate have a first set of mounting features and a second set of mounting features; and a mobile apparatus, wherein the first and second sets of mounting features directly connect the mounting plate to the mobile apparatus.

### CROSS REFERENCE TO RELATED APPLICATION

This application claims the benefit of priority of U.S. provisional application No. 63/619,981, filed Jan. 11, 2024, the contents of which are herein incorporated by reference.

### BACKGROUND OF THE SUBJECT DISCLOSURE

The present invention relates to intercoms and, more particularly, a trailer mounted intercom.

An intercom, also called an intercommunication device, is a stand-alone voice communications system for use at an entry point to a building or other forms of property. The intercom functions independently of the public telephone network. Intercoms are generally mounted permanently in buildings or on the property it is associated with; for instance, current intercoms on the market are mounted on poles, buildings, and other stationary objects. As a result of being fixed, prior art intercoms cannot be moved without rewiring the device and most likely hiring a contractor to perform the work. In sum, current intercoms are permanently anchored to the location where original installed, thereby frustrating attempts to quickly deploy the intercom in a new location.

As can be seen, there is a need for a trailer mounted intercom making them inherently mobile. The intercoms embodied in the present invention are mounted on a mobile trailer platform, making it easily relocate and deploy the intercom in different locations, which lends itself to advantages over the prior art. In one instance, the subject disclosure makes it easier for law enforcement to respond to emergency situations.

### SUMMARY OF THE SUBJECT DISCLOSURE

In addition to being mobile, the trailer mounted intercoms are adaptable to different locations and do not require a contractor to move the present invention to a different location. All a user needs to do is move the trailer to a new site and that new place has two-way communication, night vision, and other control devices that can be operatively associated with the intercom.

In one aspect of the subject disclosure, an intercom and mobile apparatus system provides the following: an intercom having a main housing defining a compartment; a mounting plate connected directly to a rear surface of the main housing, the mounting plate have a first set of mounting features and a second set of mounting features; and a mobile apparatus, wherein the first and second sets of mounting features directly connect the mounting plate to the mobile apparatus.

In another aspect of the subject disclosure, the intercom and mobile apparatus system further includes wherein each set of the first and second sets of mounting features are a plurality of mounting holes, wherein the first and second sets of mounting features are spaced at least twelve inches apart, wherein a rain shroud disposed over an intercom panel of the intercom, wherein a blue emergency light housed within the main housing though externally visible, and wherein the mobile apparatus is a vehicle, a skid, a pallet, a vehicle, or a mobile trailer; further, in one embodiment, wherein the mobile trailer includes a post, wherein the first and second sets of mounting features directly connect the mounting plate to the post.

These and other features, aspects and advantages of the present subject disclosure will become better understood with reference to the following drawings, description and claims.

### BRIEF DESCRIPTION OF THE DRAWINGS

FIG. 1 is a top front perspective view of an exemplary embodiment of the subject disclosure.

FIG. 2 is a bottom rear perspective view of an exemplary embodiment of the subject disclosure.

FIG. 3 is a front elevation view of an exemplary embodiment of the subject disclosure.

FIG. 4 is a rear elevation view of an exemplary embodiment of the subject disclosure.

FIG. 5 is a side elevation view of an exemplary embodiment of the subject disclosure.

FIG. 6 is a perspective view of an exemplary embodiment of the subject disclosure, shown in a used condition.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

Broadly, an embodiment of the subject disclosure provides an intercom and mobile apparatus system providing an intercom having a main housing defining a compartment; a mounting plate connected directly to a rear surface of the main housing, the mounting plate have a first set of mounting features and a second set of mounting features; and a mobile apparatus, wherein the first and second sets of mounting features directly connect the mounting plate to the mobile apparatus.

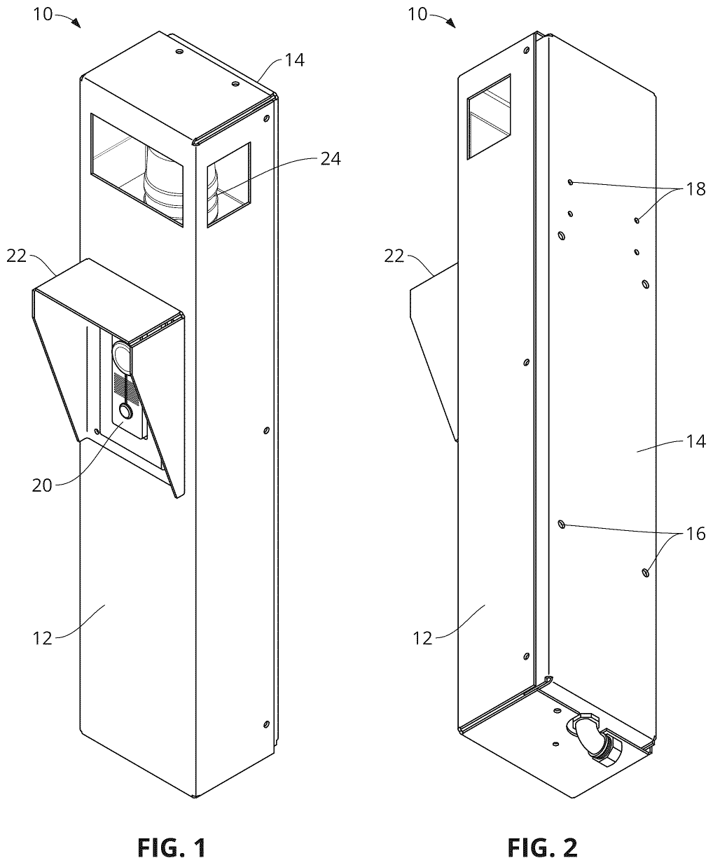

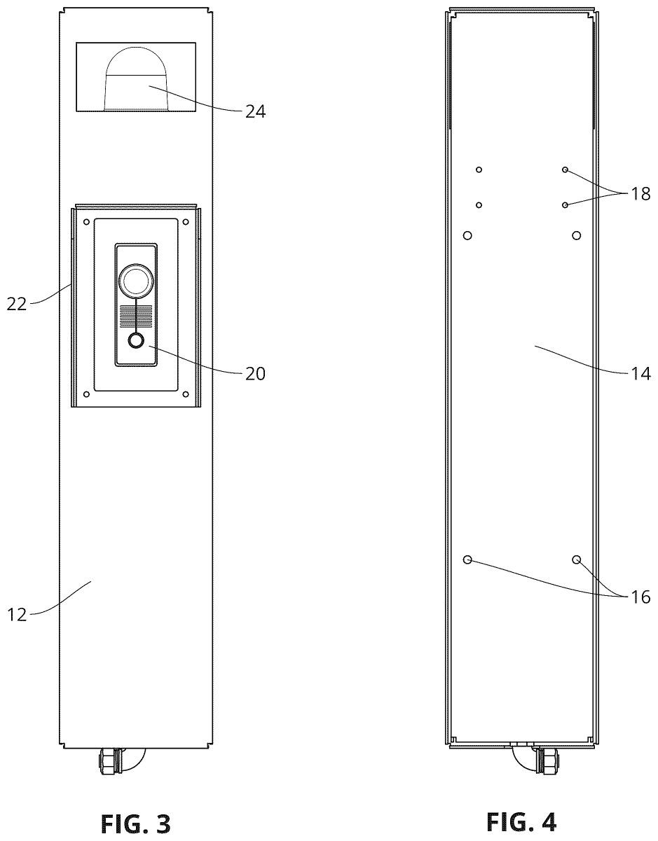

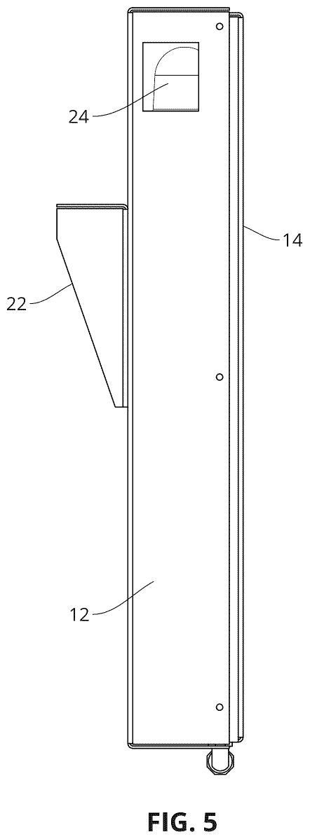

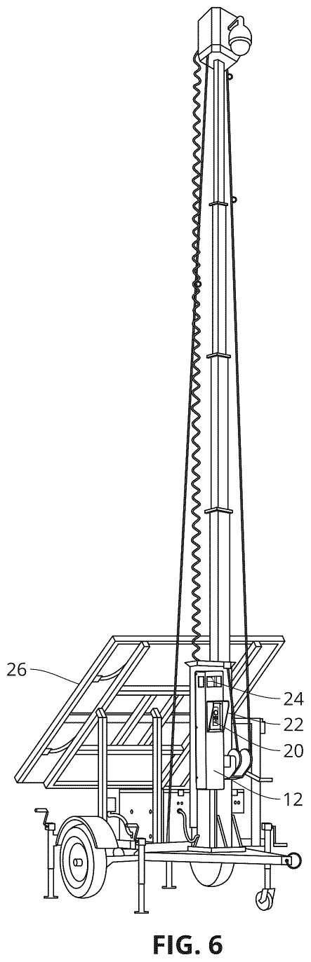

Referring to FIGS. 1 through 6, the subject disclosure provides a trailer mounted intercom 10 having a main housing 12 defining a compartment housing control device equipment associated with the intercom 10. Such equipment may include a power source for an intercom panel 20, a light source 24, or other control devices. The intercom panel 20 may be shielded by a rain shroud 22. The light source 24 may include a blue emergency light 10 to increase visibility and enabling night vision capabilities.

The main housing 12 may be, but is not required to be, generally an elongated rectangular prism. The main housing 12 may have a trailer mounting backplate 14 that defines or is coupled to the rear face, or a substantial portion, of the rectangular prism/main housing 12. The trailer mounting backplate 14 provides a first set of mounting features 16 and a second set of mounting features 18 for mounting the trailer mounted intercom 10 to a mobile security trailer 26.

The trailer mounted intercom 100 comes as an assembly configured so that two-way communication is always enabled in the event of an emergency. This assembly can be mounted on a pole, trailer, vehicle, or any mobile platform 26 with the trailer mounted bracket and/or trailer mounting backplate 14.

The first set of mounting features 16 and the second set of mounting features 18 may be a plurality of holes or other structure for removably attaching the trailer mounted intercom 100 to the mobile platform 26. The first set of mounting features 16 and the second set of mounting features 18 may be spaced apart by at least twelve inches.

The light source 24 makes the assembly visible during the day and night. The trailer mounted bracket/backplate 14 makes it possible to mount to most surfaces like a pole, trailer, vehicle etc. The rain shroud 22 prevents direct sunlight or rain from causing wear to the intercom panel 20. The systemic components herein culminate in an assembly making it possible to have emergency communication at virtually any location.

A method of making the present invention may include a manufacturer designing from a sheet metal assembly, installing an intercom system, and mounting it on a mobile relocatable trailer or vehicle.

A method of using the present invention may include the following. A person can use this system to replace other intercom systems on the market. They can use this system to rapidly respond to an emergency event. While current intercoms require construction, the system embodied in the subject disclosure advantageously can be moved at a moment's notice.

As used in this application, the term “about” or “approximately” refers to a range of values within plus or minus 10% of the specified number. And the term “substantially” refers to up to 80% or more of an entirety. Recitation of ranges of values herein is not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. An intercom and mobile apparatus system, the system comprising:
an intercom having a main housing defining a compartment;
a mounting plate connected directly to a rear surface of the main housing, the mounting plate have a first set of mounting features and a second set of mounting features; and
a mobile apparatus, wherein the first and second sets of mounting features directly connect the mounting plate to the mobile apparatus.

2. The system of claim 1, further comprising wherein each set of the first and second sets of mounting features are a plurality of mounting holes.

3. The system of claim 2, further comprising wherein the first and second sets of mounting features are spaced at least twelve inches apart.

4. The system of claim 3, further comprising a rain shroud disposed over an intercom panel of the intercom.

5. The system of claim 4, further comprising a blue emergency light housed within the main housing though externally visible.

6. The system of claim 1, wherein the mobile apparatus is a vehicle.

7. The system of claim 1, wherein the mobile apparatus is a skid or a pallet.

8. The system of claim 1, wherein the mobile apparatus is a vehicle.

9. The system of claim 1, wherein the mobile apparatus is a mobile trailer.

10. The system of claim 9, wherein the mobile trailer comprises a post, wherein the first and second sets of mounting features directly connect the mounting plate to the post.
